(19) United States
(12) Patent Application Publication
(10) Pub. No.: US 2010/0163172 A1
(43) Pub. Date: Jul. 1, 2010

(54) METHOD FOR MANUFACTURING WIRING BOARD WITH BUILT-IN COMPONENT

(75) Inventors: Kenichi Saita, Komaki-shi (JP); Shinji Yuri, Kasugai-shi (JP); Shinya Miyamoto, Konan-shi (JP); Shinya Suzuki, Kasugai-shi (JP)

Correspondence Address: STITES & HARBISON PLLC, 1199 NORTH FAIRFAX STREET, SUITE 900, ALEXANDRIA, VA, 22314, US

(73) Assignee: NGK Spark Plug Co., Ltd.

(21) Appl. No.: 12/647,771

(22) Filed: Dec. 28, 2009

(30) Foreign Application Priority Data
Dec. 26, 2008 (JP) 2008-332596
Dec. 24, 2009 (JP) 2009-291745

(51) Int. Cl. B32B 38/00

(52) U.S. Cl. 156/272.6

(57) ABSTRACT

A method for manufacturing a wiring board includes a core substrate preparation step, a component preparation step, an accommodation step, a resin layer formation step, a fixing step, an insulation layer and a surface activation step. In the accommodation step, a component is held in an accommodation hole of a core substrate. In the resin layer formation step, a gap between an inner wall surface of the accommodation hole and a side surface of the component is filled with a resin layer. In the fixing step, the resin layer is hardened. In the insulation layer formation step, a resin insulation layer is formed on a second major surface and a second component major surface. In the surface activation step, a surface of the resin layer is activated by means of plasma treatment, after the fixing step but before the insulation layer formation step.

### CROSS-REFERENCE TO RELATED APPLICATIONS

This application claims priority from Japanese Patent Application No. 2008-332596 filed on Dec. 26, 2008 and Japanese Patent Application No. 2009-291745 filed on Dec. 24, 2009, the entire contents of which are incorporated herein by reference.

### BACKGROUND OF THE INVENTION

1. Field of the Invention

The present invention relates to a method for manufacturing a wiring board with a built-in component in which components, such as capacitors, are accommodated.

2. Description of Related Art

A semiconductor integrated circuit element (an IC chip) employed as a microprocessor, and the like, of a computer recently attains higher speed and greater functionality. In association with this, a number of terminals increases and a pitch between terminals is also narrower. In general, a plurality of terminals are densely arrayed on a bottom surface of an IC chip, and such a group of terminals is connected to a group of terminals on a mother board in the form of a flip-chip package. Since a pitch between the terminals of the IC chip greatly differs from a pitch between the terminals of the mother board, it is difficult to connect the IC chip directly onto the mother board. For this reason, there is in ordinary cases adopted a technique of fabricating a package in which an IC chip is mounted on a wiring board for implementation of the IC chip and of mounting the package on a mother board. In order to diminish switching noise of the IC chip and stabilize a source voltage, the wiring board used for implementation of the IC chip of the package of this type has hitherto been proposed to be provided with a capacitor. An example of a wiring board includes a capacitor embedded in a core substrate made of a polymeric material and build-up layers made respectively on a front face and a rear face of the core substrate (see; for instance, JP-A-2007-103789).

An example of a related-art method for manufacturing a wiring board is described hereunder. First, there is prepared a core substrate 204 that has an accommodation hole 203 opening toward both a first major surface 201 and a second major surface 202 and that is made of a polymeric material (see FIG. 15). Additionally, there is prepared a capacitor 208 (see FIGS. 16 and 17) having a first capacitor major surface 205 on which a plurality of surface layer electrodes 207 are projectingly provided and a second capacitor major surface 206 on which the plurality of surface layer electrodes 207 are projectingly provided as well (see FIGS. 16 and 17). Next, processing pertaining to a taping process for affixing an adhesive tape 209 to the second major surface 202 is performed, thereby previously sealing the opening in the second major surface 202 of the accommodation hole 203. Processing pertaining to an accommodation process for placing the capacitor 208 in the accommodation hole 203 is performed, and the second capacitor major surface 206 is affixed to a adhesive face of the adhesive tape 209, to thus be temporarily fixed (see FIG. 16). A gap A1 between an inner wall surface of the accommodation hole 203 and a side surface of the capacitor 208 is filled with a portion of a resin layer 210 adjoining the first major surface 201. The capacitor 208 is fixed by subjecting the resin layer 210 to hardening and shrinkage (see FIG. 17). After removal of the adhesive tape 209, a resin insulation layer and a conductor layer are stacked one on top of the other on the first major surface 201, to thus form a first build-up layer. A resin layer and a conductor layer are stacked on the second principal plane 202 one on top of the other, to thus form a second build-up layer. As a consequence, a desired wiring board is obtained.

### BRIEF SUMMARY OF THE INVENTION

Incidentally, in the resin layer 210, a first surface 211 adjoining the resin insulation layer which makes up the first build-up layer and a second surface 212 adjoining a resin insulation layer which makes up the second build-up layer sometimes become inactive as a result of adhesion of extraneous matters to the surfaces. In particular, the second surface 212 has remained in contact with an adhesive face of the adhesive tape 209 that easily attracts extraneous matters and has a high probability of becoming inactive. As a consequence, a problem may arise in adhesion between the resin layer 210 and the resin insulation layer adjoining the first surface 211 and the second surface 212 of the resin layer 210. Therefore, there is a risk of a wiring board manufactured becoming defective as a result of an occurrence of delamination between the resin layer 210 and the resin insulation layer, to thus deteriorate reliability of the wiring board.

The present invention has been conceived in light of the problem, and an object thereof is to provide a method for manufacturing a wiring board with a built-in component that enables manufacture of a wiring board with a highly reliable built-in component by enhancing adhesion between a resin layer and a resin insulation layer.

According to an aspect of the invention, there is provided a method for manufacturing a wiring board with a built-in component comprising: a core substrate preparation step for preparing a core substrate having a first major surface, a second major surface, and an accommodation hole opened at least in the first major surface; a component preparation step for preparing a component having a first component major surface, a second component major surface, and a side surface; an accommodation step for holding the component in the accommodation hole after the core substrate preparation step and the component preparation step, while the second major surface and the second component major surface are oriented toward a same side; a resin layer formation step for filling a gap between an inner wall surface of the accommodation hole and the side surface of the component with a resin layer after the accommodation step; a fixing step for hardening the resin layer after the resin layer formation step, to thus fix the component; an insulation layer formation step for forming a resin insulation layer on the second major surface and the second component major surface after the fixing step; and a surface activation step for activating a surface of the resin layer by means of plasma treatment, after the fixing step but before the insulation layer formation step.

Therefore, according to the method for manufacturing the wiring board with a built-in component, the surface of the resin layer is activated in the surface activation step, whereby the resin insulation layer can reliably be brought into close contact with the surface of the resin layer when the resin insulation layer is formed in the insulation layer formation step. For this reason, the occurrence of delamination, or the like, can be prevented. Consequently, a highly-reliable wiring board with a built-in component can be produced.

The method for manufacturing a wiring board with a built-in component is hereunder described.

In the core substrate preparation step, a core substrate of the wiring board with a built-in component is manufactured by the related-art well-known technique and prepared in advance. The core substrate is formed into the shape of a plate having, for instance, a first major surface, a second major surface situated at an opposite position, and an accommodation hole for housing a component. The accommodation hole may also be a closed-end hole opened in only the first major surface or a through hole opened in both the first major surface and the second major surface.

Although particular limitations are not imposed on a material for forming a core material, a preferred core substrate is mainly made of a polymeric material. A specific example of polymeric materials used for forming a core substrate may by EP resins (epoxy resins), PI resins (Polyimide resins), BT (bismaleimide triazine) resins, PPE (polyphenylene ether) resins, or the like.

In the component preparation step, components for forming the wiring board with a built-in component are manufactured and prepared in advance by means of a hitherto well-known technique. A component has a first component primary surface, a second component primary surface, and a side surface. Although the shape of a component can arbitrarily be set, the first component primary surface is preferably a plate that is larger than the component side surface in terms of an area. By means of this shape, when the component is held in the accommodation hole, a distance between an inner wall surface of the accommodation hole and the side surface of the component becomes shorter, so that the volume of a resin layer arranged in the accommodation hole does not need to be much increased. A polygonal shape with a plurality of sides when viewed in a plane direction is preferable as the shape of the component achieved when viewed in a plane direction. The polygonal shape achieved when viewed in a plane direction includes; for instance, a substantially-rectangular shape achieved when viewed in a plane direction, a substantially-triangle shape achieved when viewed in a plane direction, a hexagonal shape achieved when viewed in a plane direction, and the like. In particular, a substantially-rectangular shape achieved when viewed in a plane direction, which is a common shape, is desirable. The word “substantially-rectangular shape achieved when viewed in a plane direction” is assumed to imply a shape with chamfered corners and a shape with partially-curved sides as well as a perfect rectangular shape achieved when viewed in a plane direction.

A capacitor, a semiconductor integrated circuit element (an IC chip), a MEMS (Micro Electro Mechanical Systems) element manufactured through semiconductor manufacturing processes, and the like, can be mentioned as the preferred components.

A preferred example of the capacitor may be a chip capacitor. Another example of the capacitor may be a capacitor including: a plurality of internal electrode layers stacked with dielectric layers sandwiched therebetween; a plurality of intra-capacitor via conductors connected to the plurality of internal electrode layers; and a plurality of surface electrodes connected to at least ends of the second component major surface in the plurality of intra-capacitor via conductors. A preferred capacitor is of a via array type in which the plurality of intra-capacitor via conductors are arranged on the whole in the form of an array. Such a structure enables a reduction in inductance of a capacitor and a high-speed power supply for absorbing noise and smoothing power fluctuations. Further, it becomes easy to make the entirety of the capacitor compact and, by extension, make the entire wiring board with a built-in component compact. Moreover, the capacitor is easy to achieve high electrostatic capacitance for its compactness and can supply more stable power.

A dielectric layer including a ceramic dielectric layer, a resin dielectric layer, and a ceramic-resin composite material, and others, is mentioned as the dielectric layer in a capacitor.

No limitations are imposed on the internal electrode layer, the intra-capacitor via conductors, and the surface electrode. However, when the dielectric layer is a ceramic dielectric layer, a metallized conductor, for instance, is preferable as the dielectric layer. The metallized conductor is made by applying a conductor paste including metal powder by means of a related-art known technique; for instance, a metalize-printing technique and thereafter sintering the paste.

In a subsequent accommodation step, the component is held in the accommodation hole while the second major surface and the second component major surface are oriented toward a same side. The component may also be held in the accommodation hole while fully embedded or while a portion of the component projects out of the opening of the accommodation hole. However, holding the component in the accommodation hole while fully embedded is preferable. If the component is held in such a manner, projection of the component from the opening of the accommodation hole, which would otherwise arise when processing pertaining to the accommodation step is completed, can be prevented. Further, when the resin insulation layer is formed over the second major surface and the second component major surface in the subsequent insulation layer formation step, the surface of the resin insulation layer contacting the second major surface and the second component major surface can be made smooth, so that dimensional accuracy of a wiring board with a built-in component is enhanced.

In a subsequent resin layer formation step, a gap between the inner wall surface of the accommodation hole and the side walls of the component is filled with a resin layer. The resin layer used for filling the gap between the inner wall surface of the accommodation hole and the side surface of the component in the resin layer formation step can appropriately be selected in consideration of an insulation property, heat resistance, humidity resistance, and the like. A preferred example of polymeric materials used for forming the resin layer may be an epoxy resin, a phenol resin, an urethane resin, a silicone resin, a polyimide resin, or the like.

The resin layer is further formed over the first major surface and the first component major surface in the resin layer formation step, and preferably comprises a resin sheet. In the resin layer formation step, the gap between the inner wall surface of the accommodation hole and the side surface of the component may also be filled with a portion of the resin sheet by heating the resin sheet and pressing the resin sheet against the core substrate and the component. By means of adoption of the structure, handling of the resin layer performed when the gap between the inner wall surface of the accommodation hole and the side surface of the component is filled with a resin layer becomes easier when compared with a case where the resin layer is liquid. Conversely, so long as the resin layer is liquid, a follow-up of a resin layer to a component will be improved.

It is also preferable that the resin layer be formed from a resin material having substantially the same composition as that of the resin insulation layer. By means of such a composition, a necessity for preparing a material differing from the resin insulation layer at the time of formation of a resin layer is obviated. Therefore, since the amount of material required to manufacture a wiring board with a built-in component is reduced, the cost of the wiring board with a built-in component can be curtailed.

In a subsequent fixing step, the resin layer is cured, to thus fix the component. When the resin layer is a thermosetting resin, heating an unhardened resin layer is mentioned as a step for hardening the resin layer. When the resin layer is a thermoplastic resin, cooling the resin layer heated in the resin layer formation step, and the like, is mentioned as a step for curing a resin layer.

If the second component major surface of the component and the surface of the resin layer are not level with the second major surface at a point in time when processing pertaining to the fixing step has completed, a surface of a resin insulation layer which will contact the second major surface, the second component major surface, and the surface of the resin layer cannot be made plane when the resin insulation layer is formed in a subsequent resin insulation layer formation step. As a result, dimensional accuracy of the wiring board with a built-in component is deteriorated. Even when the second component major surface and the surface of the resin layer are level with the second major surface, a problem will occur in adhesion between the resin layer and the resin insulation layer if the surface of the resin layer is inactive, which will in turn induce delamination between the resin layer and the resin insulation layer. Accordingly, processing pertaining to the accommodation step, the resin layer formation step, and the fixing step is performed while the opening of the accommodation hole in the second major surface, in which the accommodation hole has the openings in both the first major surface and the second major surface, is closed with an adhesive tape having a adhesive face. It is preferable to perform a surface activation step for activating the surface of the resin layer after removal of the adhesive tape, after the fixing step and before the insulation layer formation step. In such a case, the second component major surface side of the component is bonded to the adhesive face of the adhesive tape in the accommodation step, to thus become temporarily fastened. Further, the second component major surface becomes level with the second major surface. Further, the surface of the resin layer becomes level with the second major surface and the second component major surface in the resin layer formation step. Therefore, the surface of the resin insulation layer contacting the second major surface, the second component major surface, and the surface of the resin layer can be made planar, so that the dimensional accuracy of the wiring board with a built-in component is enhanced. Further, since the surface of the resin layer is activated, the resin layer and the resin insulation layer can reliably be brought into close contact with each other, so that the occurrence of delamination can be prevented. Therefore, processing pertaining to a layered wiring area formation step for forming a layered wiring area including a resin insulation layer and a conductor layer stacked one on top of the other is performed. After the layered wiring area formation step, there is performed processing pertaining to a solder bump formation step for forming solder bumps used for implementing a semiconductor integrated circuit element on a conductor layer formed on the outermost resin insulation layer. In such a case, coplanarity of the surface of the layered wiring area is enhanced, so that heights of respective solder bumps become less likely to vary. Therefore, reliability of a connection between the solder bumps and the semiconductor integrated circuit element is enhanced.

The word “coplanarity” referred to in the present specification is an index exhibiting uniformity of the lowest surface of terminals defined in “Standards of Electronic Industries Association of Japan EIAJ ED-7304 Method for measuring specified BGA dimensions”; namely, uniformity of a surface of a layered wiring area.

In a subsequent insulation layer formation step, the resin insulation layer is formed over the second major surface and the second component major surface. It is preferable that the wiring board with a built-in component should have a layered wiring area including the resin insulation layer and the conductor layer stacked on the second major surface and the second component major surface. Such a structure makes it possible to configure electric circuitry in the layered wiring area, and hence the function of the wiring board with a built-in component can further be enhanced. Moreover, the layered wiring area is formed only over the second major surface and the second component major surface. A layered area having the same structure as that of the layered wiring area may also be formed over the first major surface and the first component major surface. If such a structure is adopted, electric circuitry can also be made in the layered area formed over the first major surface and the first component major surface as well as in the layered wiring area formed over the second major surface and the second component major surface. Hence, the function of the wiring board with a built-in component can further be enhanced.

The resin insulation layer can appropriately be selected in consideration of an insulation property, heat resistance, humidity resistance, and the like. A preferred example of polymeric materials used for forming the resin insulation layer may be: a thermosetting resin such as an epoxy resin, a phenol resin, an urethane resin, a silicone resin, or a polyimide resin; or a thermoplastic resin such as a polycarbonate resin, an acrylic resin, a polyacetal resin, and a polypropylene resin.

Meanwhile, the conductor layer can be formed from a conductive metallic material. For instance, copper, silver, iron, cobalt, nickel, and the like, are mentioned as a metallic material for forming a conductor layer.

A surface activation step for activating the surface of the resin layer is performed after the fixing step and before the insulation layer formation step. The term “surface activation” referred to herein means modification of a surface of a resin layer by elimination of the cause for making the surface of the resin layer inactive, through use of a physical technique and a chemical technique.

The technique for activating the surface of the resin layer through use of a physical technique and a chemical technique in the surface activation step includes a method for activating the surface of the resin layer by performance of plasma treatment, a method for activating the surface of the resin layer by performance of corona processing, ozone processing, UV irradiation processing, and the like. The term “plasma treatment” means treatment for activating a surface of a resin layer by irradiating the surface of the resin layer with plasma. The term “corona processing” means processing for activating a surface of a resin layer located on a discharge plane by performing corona discharge for applying a high voltage to an electrode. “Ozone processing” means processing for activating a surface of a resin layer by spraying ozone on a surface of a resin layer. “UV irradiation processing” means processing for activating a surface of a resin layer by irradiating the surface of the resin layer with UV radiation.

In the surface activation step, using a technique for activating a surface of a resin layer by performance of plasma treatment is particularly preferable. Use of the technique makes it possible to activate the surface of the resin layer without fail.

Plasma treatment involves use of a plasma system that generates oxygen plasma, a plasma system that generates argon plasma, a plasma system that generates hydrogen plasma, a plasma system that generates helium plasma, a plasma system that generates nitrogen plasma, and the like. In particular, use of the plasma system that generates oxygen plasma is preferable.

The plasma system that generates oxygen plasma preferably generates plasma by use of a mixed gas including oxygen at a mixture ratio from 30 to 120 when carbon tetrafluoride is taken as one. In particularly, it is preferable to generate plasma by use of a mixed gas including oxygen at a mixture ratio from 30 to 50 when carbon tetrafluoride is taken as one. If the mixture ratio of oxygen is made larger than a value of 50, the quantity of carbon tetrafluoride per unit volume of a mixed gas will decrease. Therefore, even when plasma is generated by use of the mixed gas, it becomes impossible to efficiently activate the surface of the resin layer by means of plasma. In the meantime, if the gas mixture ratio of oxygen is made less than a value of 30, the quantity of carbon tetrafluoride per unit volume of a mixed gas will increase. However, the life of carbon tetrafluoride in the atmosphere is very long, and carbon tetrafluoride is a greenhouse effect gas that is extremely intensive as compared with carbon dioxide in terms of a global warming effect. For these reason, a burden placed on the environment by the mixed gas increases as the quantity of carbon tetrafluoride increases.

The plasma system that generates oxygen plasma preferably has a high frequency output for generating plasma ranging from 2.0 kW to 3.0 kW and a plasma irradiation time ranging from five seconds to 20 seconds. If the high frequency output for generating plasma is greater than 3.0 kW or if the plasma irradiation time becomes longer than 20 seconds, large electric power will be required to activate the plasma system, which will in turn result in an increase in the manufacturing cost of a wiring board with a built-in component. In the meantime, if the high frequency output for generating plasma is less than 2.0 kW or if the plasma irradiation time is less than five seconds, the surface of the resin layer cannot be sufficiently activated even when subjected to plasma treatment.

Moreover, the plasma system that generates oxygen plasma preferably generates plasma while the degree of vacuum is set so as to range from 3 Pa to 120 Pa. If the degree of vacuum becomes greater than 120 Pa, stable generation of plasma will become difficult. In contrast, if the degree of vacuum becomes less than 3 Pa, a high performance plasma system will be required, which will in turn incur an increase in manufacturing cost of a wiring board with a built-in component.

After the fixing step and before the surface activation step, it is preferable to perform processing pertaining to a height adjustment step for making the surface of the resin layer level with a first-major surface-side surface of the conductor layer made on the first major surface by means of rendering the resin layer thin. In the surface activation step, it is preferable to activate both the surface of the resin layer and the first-major-surface-side surface of the conductor layer. In this case, the surface of the resin layer is made level with the first-major-surface-side surface of the conductor layer by performing processing pertaining to the height adjustment step. Therefore, when a resin insulation layer is formed over the first major surface and the first component major surface as well as on the second major surface and the second component major surface in an insulation layer formation step subsequent to the height adjustment step, the resin insulation layer can reliably be brought into close contact with the surface of the resin layer. As a consequence, the occurrence of delamination, and the like, can be prevented more thoroughly; hence, a wiring board with a built-in component exhibiting much superior reliability can be produced.

A technique for mechanically eliminating a portion of the resin layer, a technique for chemically eliminating a portion of the resin layer, and the like, can be mentioned as the technique for making the surface of the resin layer level with the first-major-surface-side surface of the conductor layer by means of rendering the resin layer thin in the height adjustment step. However, it is desirable to mechanically eliminate a portion of the resin layer in the height adjustment step. In such a case, processing pertaining to the height adjustment step can be performed in a more simple manner and at a lower cost when compared with a case where a portion of the resin layer is chemically eliminated.

Other features and advantages of the invention will be set forth in, or apparent from, the detailed description of the exemplary embodiments of the invention found below.

### BRIEF DESCRIPTION OF THE DRAWINGS

FIG. 1 is a general cross-sectional view of a wiring board of an exemplary embodiment of the present invention;

FIG. 2 is a general cross-sectional view of an exemplary ceramic capacitor;

FIG. 3 is a general schematic view of an inner layer of the exemplary ceramic capacitor;

FIG. 4 is a general schematic view of an inner layer of the exemplary ceramic capacitor;

FIG. 5 is a flowchart of an exemplary method for manufacturing a wiring board according to the invention;

FIG. 6 is a cross-sectional view of a wiring board at a step during the exemplary method for manufacturing a wiring board;

FIG. 7 is a cross-sectional view of the wiring board at a step during the exemplary method for manufacturing a wiring board;

FIG. 8 is a cross-sectional view of the wiring board at a step during the exemplary method for manufacturing a wiring board;

FIG. 9 is a cross-sectional view of the wiring board at a step during the exemplary method for manufacturing a wiring board;

FIG. 10 is a cross-sectional view of the wiring board at a step during the exemplary method for manufacturing a wiring board;

FIG. 11 is a cross-sectional view of the wiring board at a step during the exemplary method for manufacturing a wiring board;

FIG. 12 is a cross-sectional view of the wiring board at a step during the exemplary method for manufacturing a wiring board;

FIG. 13 is a cross-sectional view the wiring board at a step during of the exemplary method for manufacturing a wiring board;

FIG. 14 is a cross-sectional view of the wiring board at a step during the exemplary method for manufacturing a wiring board;

FIG. 15 is a cross-sectional view of a wiring board at a step during a related-art method for manufacturing a wiring board;

FIG. 16 is a similar cross-sectional view of the wiring board at a step during the related-art method for manufacturing a wiring board; and

FIG. 17 is a similar cross-sectional view of the wiring board at a step during the related-art method for manufacturing a wiring board.

### DETAILED DESCRIPTION OF EXEMPLARY EMBODIMENTS OF THE INVENTION

A wiring board with a built-in component according to an embodiment of the present invention is hereinbelow described in detail with reference to the drawings.

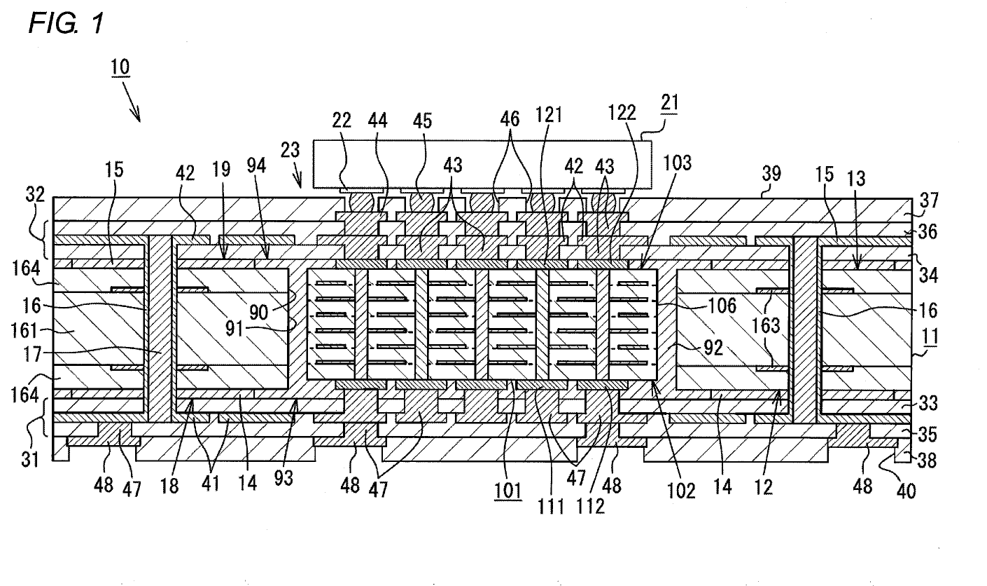

As shown in FIG. 1, a wiring board with a built-in component of the present embodiment (hereinafter called “wiring board”) 10 is a wiring board used for implementation of an IC chip. The wiring board 10 includes a core substrate 11 assuming the shape of a substantially-rectangular plate; a first build-up layer 31 made on a first major surface 12 (a lower surface in FIG. 1) of the core substrate 11; and a second build-up layer 32 (a layered wiring area) made on a second major surface 13 (an upper surface in FIG. 1) of the core substrate 11.

The core substrate 11 of the embodiment assumes the shape of a substantially-rectangular plate measuring 25 mm high×25 mm wide×1.0 mm thick when viewed in a plane direction. The core substrate 11 exhibits a thermal expansion coefficient of 10 to 30 ppm/° C. or thereabouts (specifically 18 ppm/° C.) in the direction of a plane (an XY direction). A thermal expansion coefficient of the core substrate 11 refers to an average of measured values ranging from 0° C. to a glass transition temperature (Tg). The core substrate 11 is comprised of a base material 161 made of glass epoxy; a sub-base material 164 that is made on the upper and lower surfaces of the base material 161 and that is made of an epoxy resin doped with an inorganic filler, such as a silica filler; and a conductor layer 163 made of copper on upper and lower surfaces of the base material 161.

As shown in FIG. 1, a plurality of through hole conductors 16 are made in the core substrate 11 so as to penetrate through the first major surface 12, the second major surface 13, and conductor layers 163. The through hole conductors 16 establish connection conduction between the first major surface 12 and the second major surface 13 of the core substrate 11 and electrically connect the first and second major surfaces 12 and 13 to conductor layers 163. The insides of through hole conductors 16 are filled with filled resin 17; for instance, an epoxy resin. A first-major-surface-side conductor layer 14 made of copper is made in the form of a pattern on the first major surface 12 of the core substrate 11. A second-major-surface-side conductor layer 15 made of copper in the same manner as is the first principal conductor layer is laid in the form of a pattern on the second major surface 13 of the core substrate 11. The conductor layers 14 and 15 are electrically connected to the through hole conductors 16. Further, the core substrate 11 has one accommodation hole 90 that is rectangular when viewed in a plane direction is made in the center of the first major surface 12 and the center of the second major surface 13. Specifically, the accommodation hole 90 is a through hole.

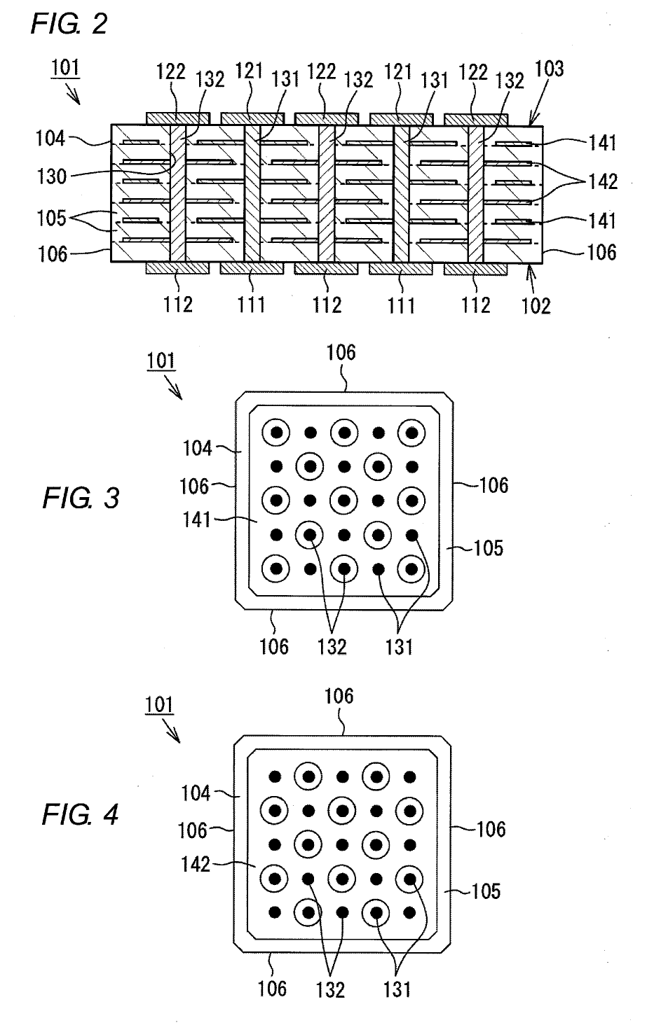

As shown in FIG. 1, a ceramic capacitor 101 (a component) shown in FIGS. 2 through 4 is held in the accommodation hole 90 in an embedded manner. The ceramic capacitor 101 is held in such a way that the first major surface 12 of the core substrate 11 and a first capacitor major surface 102 (a lower surface in FIG. 1) are oriented in the same direction and that the second major surface 13 of the core substrate 11 and a second capacitor major surface 103 (an upper surface in FIG. 1) are oriented in the same direction. The ceramic capacitor 101 of the embodiment is a substance assuming the shape of a substantially-rectangular plate measuring 14.0 mm high×14.0 mm wide×0.8 mm thick when viewed in a plane direction.

As shown in FIGS. 1 through 4, the ceramic capacitor 101 of the embodiment is of so-called via array type. A thermal expansion coefficient of a sintered ceramic element 104 of the ceramic capacitor 101 ranges from 8 to 12 ppm/° C. or thereabouts and is specifically 9.5 ppm/° C. or thereabouts. The thermal expansion coefficient of the sintered ceramic element 104 refers to an average of measured values ranging from 30° C. to 250° C. The sintered ceramic element 104 has the first capacitor major surface 102 (the lower surface in FIG. 1) that is a first component major surface, the second capacitor major surface 103 (the upper surface in FIG. 1) that is a second component major surface; and four capacitor side surfaces 106 that are the side surfaces of the component. The sintered ceramic element 104 has a structure in which an internal power electrode layer 141 and an internal ground electrode layer 142 are stacked one on top of the other with a ceramic dielectric layer 105 sandwiched therebetween. The ceramic dielectric layer 105 is made of a sintered element of barium titanate that is a kind of high dielectric ceramic and acts as a dielectric substance between the internal power electrode layer 141 and the internal ground electrode layer 142. Both the internal power electrode layer 141 and the internal ground electrode layer 142 are layers mainly containing nickel, and are stacked one after the other within the sintered ceramic element 104.

As shown in FIGS. 1 through 4, a plurality of via holes 130 are made in the sintered ceramic element 104. The via holes 130 penetrate through the sintered ceramic element 104 in its thicknesswise direction and are arranged in an array pattern (e.g., a lattice pattern) over the entirety of the ceramic sintered element. A plurality of intra-capacitor via conductors 131 and 132 for establishing mutual connection between the first capacitor major surface 102 and the second capacitor major surface 103 of the sintered ceramic element 104 are formed in the respective via holes 130 and mainly from nickel. The respective intra-capacitor power via conductors 131 penetrate through the respective internal power electrode layers 141, to thus electrically connect the electrode layers to each other. The respective intra-capacitor ground via conductors 132 penetrate through the respective internal ground electrode layers 142, thereby electrically connecting the electrode layers to each other. The respective intra-capacitor power via conductors 131 and the respective intra-capacitor ground via conductors 132 are arranged as a whole in an array pattern. In the embodiment, for convenience of explanation, the intra-capacitor via conductors 131 and 132 are illustrated in 5 lines×5 columns of a pattern. However, in reality, a greater number of lines and columns are present.

As shown in FIG. 2, a plurality of first power electrodes 111 (surface layer electrodes) and a plurality of first ground electrodes 112 (surface electrodes) are projectingly provided on the first capacitor major surface 102 of the sintered ceramic element 104. Although the respective first ground electrodes 112 are individually made on the first capacitor major surface 102, they may also be integrally made. The first power electrodes 111 are connected directly to end faces of the plurality of intra-capacitor power via conductors 131 adjoining the first capacitor major surface 102. The first ground electrodes 112 are connected directly to end faces of the plurality of intra-capacitor ground via conductors 132 adjoining the first capacitor major surface 102. A plurality of second power electrodes 121 (surface electrodes) and a plurality of second ground electrodes 122 (surface electrodes) are projectingly provided on the second capacitor major surface 103 of the sintered ceramic element 104. The respective second ground electrodes 122 are individually made on the second capacitor major surface 103 but may also be integrally made. The second power electrodes 121 are connected directly to end faces of the plurality of intra-capacitor power via conductors 131 adjoining the second capacitor major surface 103, and the second ground electrodes 122 are connected directly to the end faces of the plurality of intra-capacitor ground via conductors 132 adjoining the second capacitor major surface 103. Therefore, the power electrodes 111 and 121 are electrically connected to the intra-capacitor power via conductors 131 and the internal power electrode layers 141. The ground electrodes 112 and 122 are electrically connected to the intra-capacitor ground via conductors 132 and the internal ground electrode layers 142. The electrodes 111, 112, 121, and 122 mainly contain nickel, and their surfaces are coated with an unillustrated copper plating layer.

For instance, when a voltage is applied between the internal power electrode layers 141 and the internal ground electrode layers 142 by application of power by way of the electrodes 111 and 112, positive electric charges, for instance, are accumulated in the internal power electrode layers 141, and negative electric charges, for instance, are accumulated in the internal ground electrode layers 142. As a consequence, the ceramic capacitor 101 functions as a capacitor. In the sintered ceramic element 104, the intra-capacitor power via conductors 131 and the intra-capacitor ground via conductors 132 are arranged adjacently to each other and set in such a way that electric currents flow in opposite directions in the intra-capacitor power via conductors 131 and the intra-capacitor ground via conductors 132. As a result, inductance components are reduced.

As shown in FIG. 1, a resin layer 92 made of a polymeric material (an epoxy resin that is a thermosetting resin in the embodiment) is made on the first major surface 12 of the core substrate 11 and the first capacitor major surface 102 of the ceramic capacitor 101. A gap between an inner wall surface 91 of the accommodation hole 90 and capacitor side surfaces 106 of the ceramic capacitor 101 is filled with a portion of the resin layer 92. Specifically, the resin layer 92 has a function of fastening the ceramic capacitor 101 to the core substrate 11. A thermal expansion coefficient of the resin layer 92 achieved in a fully set state is 10 to 60 ppm/° C. or thereabouts; specifically, about 20 ppm/° C. The thermal expansion coefficient of the resin layer 92 achieved in a fully set state refers to an average of measured values ranging from 30° C. to a glass transition temperature (Tg). Further, the ceramic capacitor 101 has at its respective four corners chamfered areas, each of which has a chamfer dimension of 0.55 mm or more (a chamfer dimension of 0.6 mm in the embodiment). Since concentration of stress on the corners of the ceramic capacitor 101, which is exerted when the resin layer 92 is deformed by a temperature change, can be lessened, and hence occurrence of cracking in the resin layer 92 can be prevented.

As shown in FIG. 1, the first buildup layer 31 is structured in such a way that two resin insulation layers 33 and 35 made of a thermosetting resin (an epoxy resin) and a conductor layer 41 made of copper are stacked one on top of the other. Specifically, the resin insulation layers 33 and 35 are made of a resin material that is substantially the same composition as that of the resin layer 92. A thermal expansion coefficient of the resin insulation layers 33 and 35 assumes substantially the same value as that of the thermal expansion coefficient of the resin layer 92 achieved in the fully set state; namely, 10 to 60 ppm/° C. or thereabouts (specifically 20 ppm/° C. or thereabouts). The thermal expansion coefficient of the resin insulation layers 33 and 35 refers to an average of measured values ranging from 30° C. to the glass transition temperature (Tg). A via conductor 47 made by copper plating is provided in each of the resin insulation layers 33 and 35. Lower ends of the through hole conductors 16 are electrically connected to some areas of the conductor layer 41 on the lower surface of the first resin insulation layer 33. Portions of the via conductors 47 provided in the resin insulation layers 33 and 35 are connected to the electrodes 111 and 112 of the ceramic capacitor 101. Pads 48 to be electrically connected to the conductor layer 41 by way of the via conductors 47 are made in a lattice pattern at a plurality of locations on the lower surface of the second resin insulation layer 35. An entire lower surface of the resin insulation layer 35 is substantially covered with the solder resist 38. Openings 40 through which the pads 48 are exposed are made at predetermined locations on the solder resist 38.

As shown in FIG. 1, the second buildup layer 32 has substantially the same structure as that of the foregoing first buildup layer 31. Specifically, the second buildup layer 32 is structured in such a way that two resin insulation layers 34 and 36 made of a thermosetting resin (an epoxy resin) and a conductor layer 42 made of copper are stacked one on top of the other. The resin insulation layers 34 and 36 are specifically made of a resin material substantially the same composition as that of the resin layer 92. The thermal expansion coefficient of the resin insulation layers 34 and 36 assumes the same value as that of the thermal expansion coefficient of the resin layer 92 achieved in a fully set state; namely, 10 to 60 ppm/° C. or thereabouts (specifically 20 ppm/° C. or thereabouts). The thermal expansion coefficient of the resin insulation layers 34 and 36 refers to an average of measured values ranging from 30° C. to the glass transition temperature (Tg). A via conductor 43 made by copper plating is provided in each of the resin insulation layers 34 and 36. Upper ends of the through hole conductors 16 are electrically connected to some areas of the conductor layer 42 on the upper surface of the first resin insulation layer 34. Portions of the via conductors 43 provided in the resin insulation layers 34 and 36 are connected to the electrodes 121 and 122 of the ceramic capacitor 101. Terminal pads 44 to be electrically connected to the conductor layer 42 by way of the via conductors 43 are made in an array pattern at a plurality of locations on the upper surface of the second resin insulation layer 36. An entire upper surface of the resin insulation layer 36 is substantially covered with the solder resist 37. Openings 46 through which the terminal pads 44 are exposed are made at predetermined locations on the solder resist 37. A plurality of solder bumps 45 are placed on the respective surfaces of the terminal pads 44.

As shown in FIG. 1, the respective solder bumps 45 are electrically connected to surface connection terminals 22 of an IC chip 21 (a semiconductor integrated circuit element). The IC chip 21 of the present embodiment is a plate-like substance assuming a rectangular shape measuring 12.0 mm high×12.0 mm wide×0.9 mm thick when viewed in a plane direction, and is made of silicon having a thermal expansion coefficient of 3 to 4 ppm/° C. or thereabouts (specifically, 3.5 ppm/° C. or thereabouts). A region including the respective terminal pads 44 and the respective solder bumps 45 is an IC chip implementation region 23 where the IC chip 21 can be implemented. The IC chip implementation area 23 is set on a surface 39 of the second buildup layer 32.

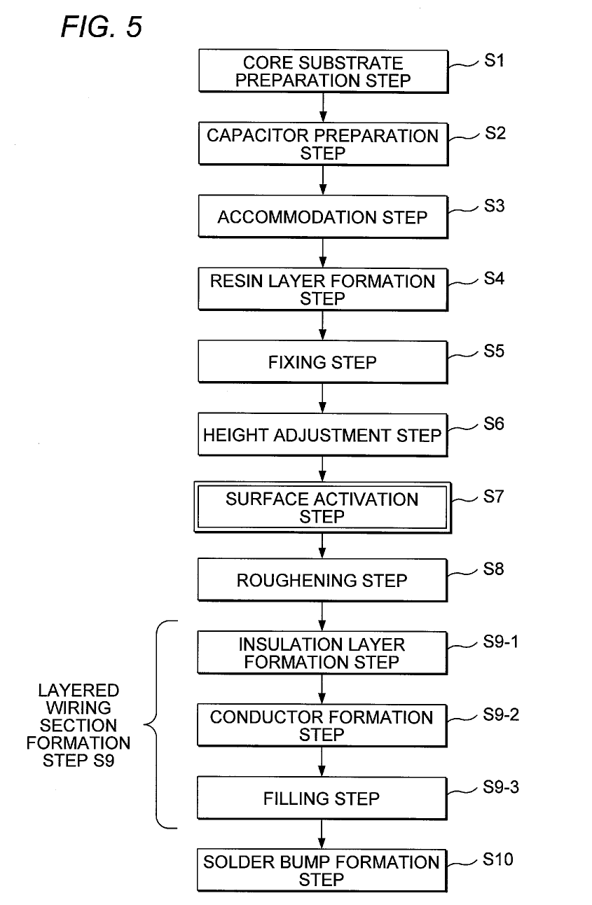

A method for manufacturing the wiring board 10 of the embodiment is now described by reference to FIGS. 5 through 14.

In a core substrate preparation step S1, a semi-manufactured product of the core substrate 11 is manufactured in advance by means of the related-art known technique.

A semi-manufactured product of the core substrate 11 is manufactured as follows. There is first prepared a copper clad laminate (omitted from the drawings) including a base material 161 measuring 400 mm high×400 mm wide×0.8 mm thick with copper foil affixed to both surfaces. Next, the copper foil on both surfaces of the copper clad laminate is etched, to thus pattern a conductor layer 163 by means of; for instance, a subtractive technique. Specifically, after subjected to electroless copper plating, the copper clad laminate is subjected to electrolytic copper plating while the electroless copper plated layer is taken as a common electrode. Moreover, the plate layer is laminated with a dry film, and the dry film is exposed and developed, whereby a predetermined pattern is made in the dry film. In this state, the unwanted electrolytic copper plated layer, the unwanted electroless copper plated layer, and the unwanted copper foil are etched away. Subsequently, the dry film is removed. After the upper and lower surfaces of the base material 161 and the conductor layer 163 have been roughened, an epoxy resin film doped with an inorganic filler (having a thickness of 80 μm) is affixed to both the upper and lower surfaces of the base material 161 by means of thermal compression, to thus produce a sub-base material 164.

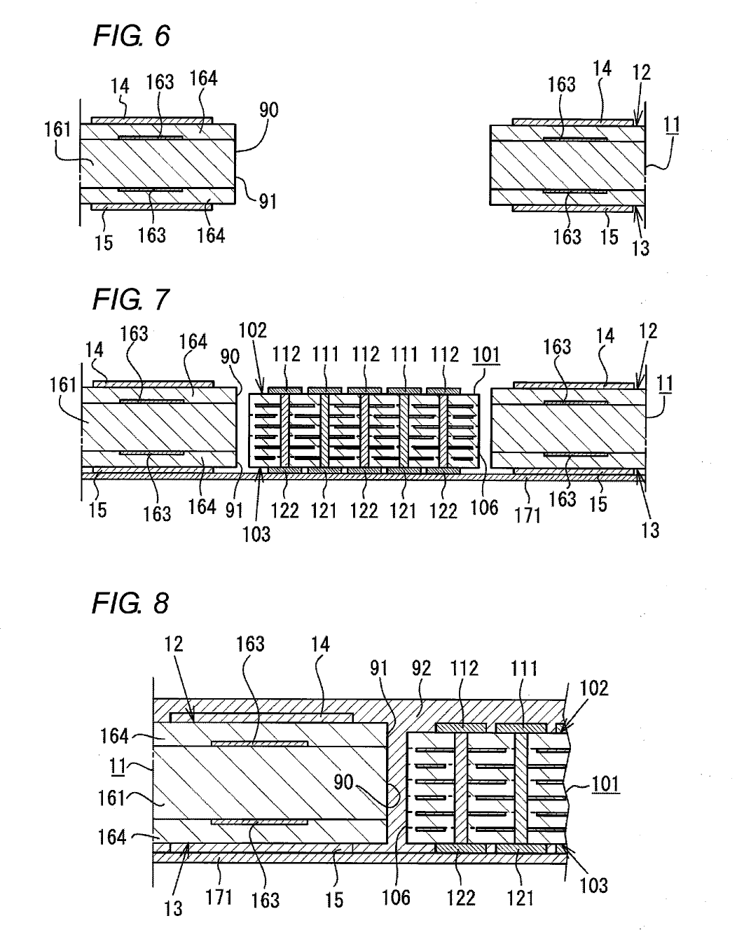

A first-major-surface-side conductor layer 14 (e.g., 50 μm) is made in the form of a pattern on an upper surface of the upper sub-base material 164, and a second-major-surface-side conductor layer 15 (e.g., 50 μm) is made in the form of a pattern on a lower surface of the lower sub-base material 164. Specifically, after an upper surface of the upper sub-base material 164 and a lower surface of the lower sub-base material 164 are subjected to electroless copper plating, an etching resist is produced, and the sub-base materials are subjected to electrolytic copper plating. Further, the etching resist is removed, and the sub-base materials are subjected to soft etching. A layered product including the base material 161 and the sub-base materials 164 is bored by use of a rooter, to thus create a through hole, which is to form the accommodation hole 90, at a predetermined location. Thus, a semi-manufactured product of the core substrate 11 is produced (see FIG. 6). The semi-manufactured product of the core substrate 11 is a multi-product core substrate in which a plurality of areas which should act as the core substrates 11 are arranged lengthwise and breadthwise along the direction of a plane.

In a capacitor preparation step S2 (a component preparation step), the ceramic capacitor 101 is manufactured by the related-art known technique and prepared in advance.

The ceramic capacitor 101 is manufactured as follows. Specifically, a ceramic green sheet is made, and a nickel paste for an internal electrode layer is printed on the green sheet by means of screen printing. The green paste is then dried. An internal power electrode which will later become the internal power electrode layer 141 and an internal ground electrode which will later become the internal ground electrode layer 142 are thereby be produced. The green sheet on which the internal power electrode is produced and the green sheet on which the internal ground electrode is made are stacked one on top of the other. Pressing force is imparted to the green sheets in the direction in which the green sheets are piled, so as to integrate the respective green sheets. A layered green sheet product is thus produced.

Further, a plurality of via holes 130 are made in the layered green sheet product by use of a laser beam machine. The respective via holes 130 are filled with nickel paste for a via conductor by use of an unillustrated paste press filler machine. Next, paste is printed on lower surfaces of the layered green sheet products, thereby generating the power electrodes 111 and 121 and the ground electrodes 112 and 122 on the respective lower surface sides of the layered green sheet products so as to cover lower end faces of the respective conductors.

Subsequently, the layered green sheet products are dried, thereby hardening the respective electrodes 111, 112, 121, and 122 to a certain extent. The layered green sheet products are then subjected to dewaxing and are further sintered at a predetermined temperature for a predetermined period of time. As a consequence, barium titanate and nickel in the paste are sintered at the same time, to thus become a sintered ceramic element 104.

The respective electrodes 111, 112, 121, and 122 of the thus-produced sintered ceramic element 104 are subjected to electroless copper plating (having a thickness of about 10 μm). A copper plating layer is made over the respective electrodes 111, 112, 121, and 122, whereupon the ceramic capacitor 101 is completed.

In a subsequent accommodation step S3, an opening of the accommodation hole 90 adjoining the second major surface 13 is sealed with a removable adhesive tape 171. The adhesive tape 171 is supported by a support bed (omitted from the drawings). Next, the ceramic capacitor 101 is placed in the accommodation hole 90 while the first major surface 12 and the first capacitor major surface 102 are oriented in the same direction and while the second major surface 13 and the second capacitor major surface 103 are also oriented in another direction by use of a mounter (manufactured by Yamaha Motor Co., Ltd.) (see FIG. 7). The second capacitor major surface 103 of the ceramic capacitor 101 is affixed to and temporarily fastened to a adhesive face of the adhesive tape 171.

In a subsequent resin layer formation step S4, the resin layer 92 is formed over the first major surface 12 and the first capacitor major surface 102, and the gap between the inner wall surface 91 of the accommodation hole 90 and the capacitor side surface 106 of the ceramic capacitor 101 is filled with a portion of the resin layer 92 (see FIG. 8). To be more specific, an unillustrated resin sheet (having a thickness of 200 μm) which is to become the resin layer 92 is laminated on the first major surface 12 and the first capacitor major surface 102. Specifically, the resin sheet is heated to 140 to 150° C., and the resin sheet is then pressed against the first major surface 12 and the first capacitor major surface 102 at 0.75 MPa for 120 seconds. The gap between the inner wall surface 91 and the capacitor side surfaces 106 is thereby filled with a portion of the resin sheet (the resin layer 92).

In a subsequent fixing step S5, the resin layer 92 is cured, to thus fix the ceramic capacitor 101 in the accommodation hole 90. Specifically, heat processing (curing, and the like) is carried out, to thus harden the resin layer 92, whereupon the ceramic capacitor 101 is fixed to the core substrate 11. After the fixing step S5, the adhesive tape 171 is removed. In short, processing pertaining to the accommodation step S3, the resin layer formation step S4, and the fixing step S5 is performed while the opening of the accommodation hole 90 adjoining the second major surface 13 is closed with the adhesive tape 171.

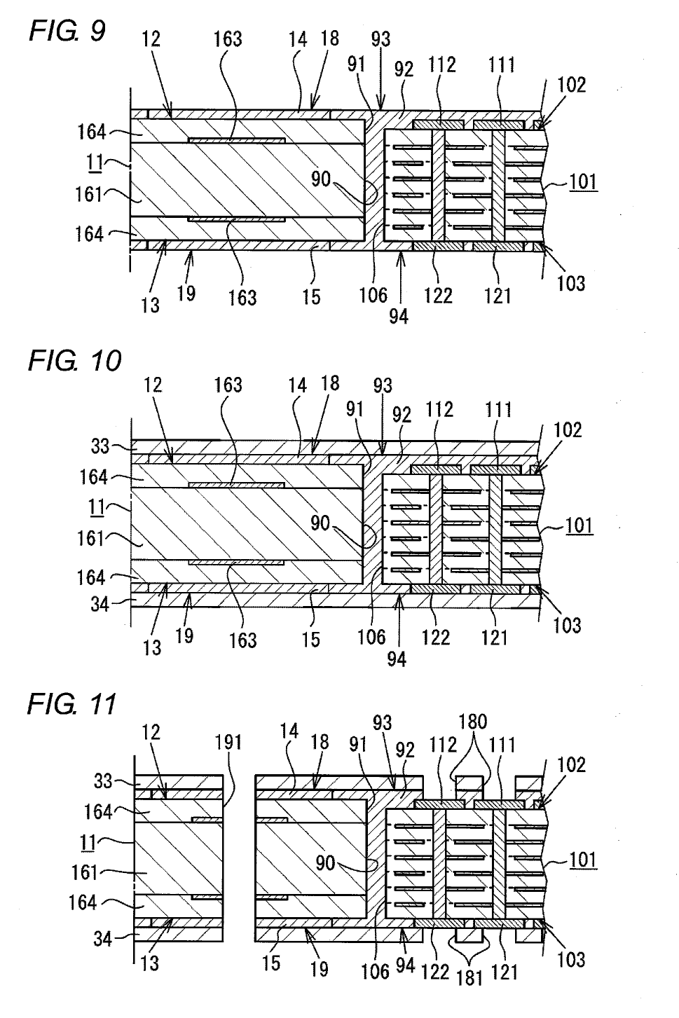

In a subsequent height adjustment step S6, the resin layer 92 is made thin, to thus make the first surface 93 (the surface) of the resin layer 92 level with the surface 18 of the first-major-surface-side conductor layer 14 (see FIG. 9). To be more specific, the surface (the first surface 93) of the resin layer 92 situated at a position higher than the upper surface 18 of the first-major-surface-side conductor layer 14 is abraded by use of a belt sander, to thus become lower. Consequently, a portion of the resin layer 92 is mechanically eliminated.

In a subsequent surface activation step S7, plasma treatment (treatment using low-pressure plasma in the present embodiment) is performed by use of a plasma system that generates oxygen plasma, whereupon the surfaces (the first surface 93 and the second surface 94) of the resin layer 92 and the surfaces 18 and 19 of the conductor layers 14 and 15 are activated. Processing pertaining to the surface activation step S7 is performed after the fixing step S5 and before an insulation layer formation step S9-1; more specifically, immediately after the height adjustment step S6. More specifically, after the wiring board 10 subjected to processing pertaining to the height adjustment step S6 is placed in a vacuum chamber of the plasma system, a mixed gas mixedly including carbon tetrafluoride, which is a fluorine-contained compound, and oxygen at a 1:40 mixing ratio is introduced into the vacuum chamber. Next, oxygen plasma is generated by use of the mixed gas. In further detail, the degree of vacuum achieved in a vacuum chamber is first set so as to range from 3 Pa to 100 Pa. A high frequency having a frequency of 13.56 MHz and a high frequency output of 2.5 kW is applied between a pair of electrodes provided in the plasma system, whereby oxygen plasma is generated. Oxygen plasma of the present embodiment is low-temperature plasma. Next, the first surface 93 and the second surface 94 of the resin layer 92 are exposed to the thus-generated oxygen plasma. The surfaces 18 and 19 of the conductor layers 14 and 15 and the surfaces of the electrodes 121 and 122 of the ceramic capacitor 101 are also exposed to the oxygen plasma. In the present embodiment, an irradiation time of oxygen plasma is set to 16 seconds. As a consequence, extraneous matters adhering to the first surface 93 and the second surface 94 of the resin layer 92 are ashed and removed, whereby the first surface 93 and the second surface 94 are modified. The surfaces 18 and 19 of the conductor layers 14 and 15 and the surfaces of the electrodes 121 and 122, which all are made of copper, remain substantially unchanged during the modification of the first surface 93 and the second surface 94.

In a subsequent roughening step S8, the surface 18 of the conductor layer 14 made on the first major surface 12 and the surface 19 of the conductor layer 15 made on the second major surface 13 are roughened (subjected to CZ treatment). The surfaces of the electrodes 121 and 122 exposed through the second surface 94 of the resin layer 92 are also roughened. After completion of processing pertaining to the roughening step S8, the layered product is subjected to a cleansing step, whereby the surfaces (the first surface 93 and the second surface 94) of the resin layers 92, the surfaces 18 and 19 of the conductor layers 14 and 15, and the surfaces of the electrodes 121 and 122 are cleansed. When necessary, the first major surface 12 and the second major surface 13 may also be subjected to coupling treatment by use of a silane coupling agent (manufactured by Shin-Etsu Chemical Co., Ltd.).

In a subsequent layered wiring area formation step S9, by means of the related-art known technique, the first buildup layer 31 is made on the first major surface 12, and the second buildup layer 32 is made on the second major surface 13. To be more specific, processing pertaining to an insulation layer formation step S9-1 is first implemented. Namely, a thermosetting epoxy resin is caused to adhere (affixed) to the second major surface 13 and the second capacitor major surface 103; specifically, the second surface 94 of the resin layer 92 and the surface 19 of the second-major-surface-side conductor layer 15, thereby generating an innermost resin insulation layer 34 on the second major surface 13 (see FIG. 10). Further, a thermosetting epoxy resin is caused to adhere (affixed) to the first major surface 12 and the capacitor major surface 102; specifically, the first surface 93 of the resin layer 92 and the surface 18 of the first-major-surface-side conductor layer 14, thereby generating an innermost resin insulation layer 33 on the first major surface 12 (see FIG. 10). The surfaces may also be covered with a photosensitive epoxy resin, an insulation resin, and liquid-crystal polymer (LCP) in place of the thermosetting epoxy resin.

Laser boring is performed by use of a YAG laser or a carbon dioxide gas laser, thereby making via holes 180 and 181 at locations where the via conductors 43 and 47 are to be made (see FIG. 11). Specifically, there is formed the via hole 180 penetrating through the resin insulation layer 33 and the resin layer 92, thereby exposing the surfaces of the electrodes 111 and 112 projectingly provided on the first capacitor major surface 102 of the ceramic capacitor 101. The via hole 181 penetrating through the resin insulation layer 34 is made, whereby the surfaces of the electrodes 121 and 122 projectingly provided on the second capacitor major surface 103 of the ceramic capacitor 101 are exposed. Boring is performed by use of a drill, thereby preliminarily forming a through hole 191 penetrating through the core substrate 11 and the resin insulation layers 33 and 34 at a predetermined position (see FIG. 11).

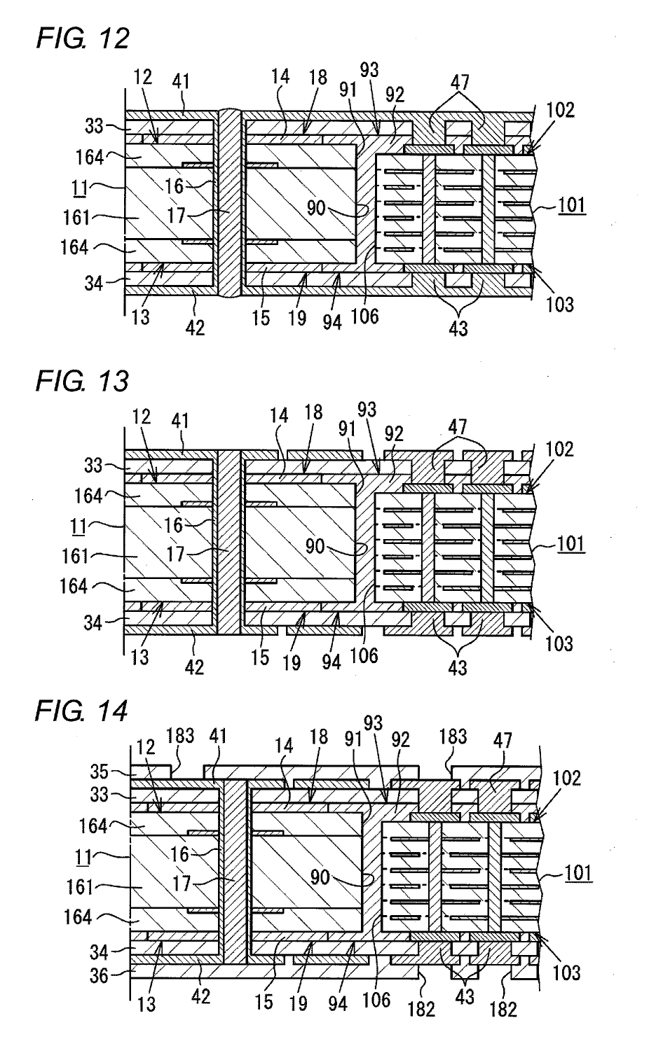

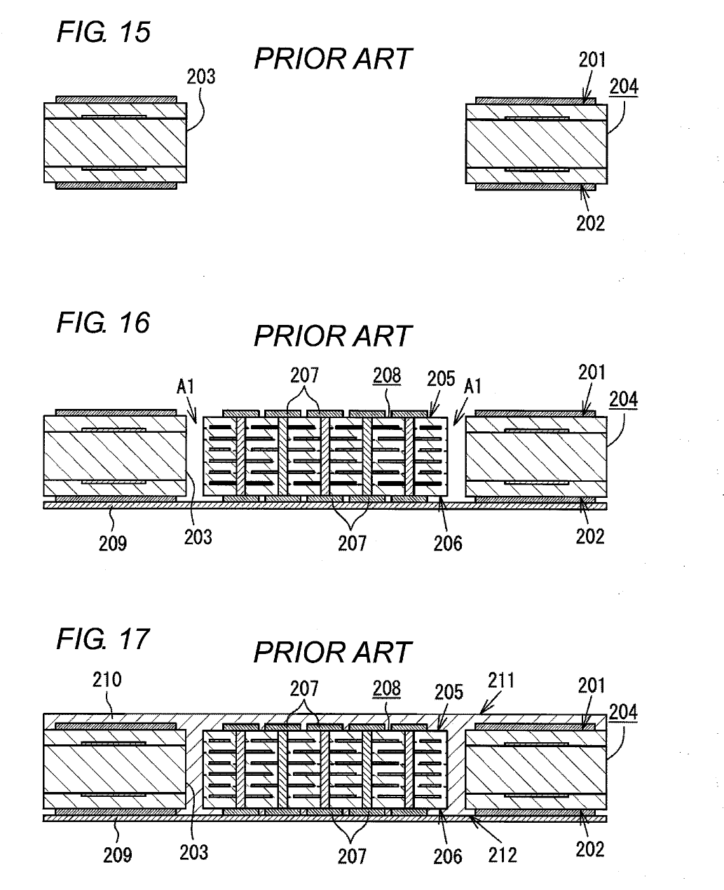

In a conductor formation step S9-2, the surfaces of the resin insulation layers 33 and 34, the inner surface of the via hole 181, and the inner surface of the through hole 191 are subjected to electroless copper plating and subsequently to electrolytic copper plating. The through hole conductor 16 is thereby made in the through hole 191; the via conductor 43 is formed in the via hole 181; and the via conductor 47 is formed in the via hole 180. Processing pertaining to a hole plugging step S9-3 is subsequently carried out. Specifically, a cavity of the through hole conductor 16 is filled with an insulation resin material (an epoxy resin), to thus create the filled resin 17 (see FIG. 12). Next, after a portion of the filled resin 17 projecting out of the opening of the through hole 191 is abraded, the laminated substrates are subjected to patterning by means of etching in conformance to the related-art technique (e.g., a subtractive technique). The conductor layer 41 is thereby produced in the form of a pattern over the resin insulation layer 33, and the conductor layer 42 is produced in the form of a pattern over the resin insulation layer 34 (see FIG. 13).

The resin insulation layers 33 and 34 are then covered with a thermosetting epoxy resin, thereby producing the outermost resin insulation layers 35 and 36 having via holes 182 and 183 at positions where the via conductors 43 and 47 are to be formed (see FIG. 14). The resin insulation layers may also be covered with a photosensitive epoxy resin, an insulation resin, and a liquid crystal polymer in lieu of the thermosetting epoxy resin. In this case, the via holes 182 and 183 are bored at the positions where the via conductors 43 and 47 are to be formed, by means of a laser beam machine, and the like. The laminated substrates are subjected to electrolytic copper plating in conformance with the related-art known technique, thereby producing the via conductors 43 and 47 in the respective via holes 182 and 183. In addition, the pads 48 are formed on the resin insulation layer 35, and the terminal pads 44 are formed on the resin insulation layer 36.

A photosensitive epoxy resin is applied over the resin insulation layers 35 and 36 and is then hardened, thereby generating the solder resists 37 and 38. The substrates are subjected to exposure and development while a predetermined mask is arranged thereon, thereby patterning the openings 40 and 46 in the solder resists 37 and 38.

In a subsequent solder bump formation step S10, a solder paste is printed on the terminal pads 44 formed on the outermost resin insulation layer 36. Next, the wiring board 10 with a printed solder paste is placed in a reflow furnace and heated to a temperature that is higher than the melting point of solder by 10 to 40° C. The solder paste is melted at this point in time, whereupon the semi-spherically bulging solder bumps 45 used for implementing the IC chip 21 are formed. The substrates in this state can be ascertained to be a multi-product wiring board in which product areas which should become the wiring boards 10 are arranged lengthwise and breadthwise along the direction of the plane. Moreover, a plurality of wiring boards 10, which each are products, can be simultaneously acquired by dividing the multi-product wiring board.

Subsequently, the IC chip 21 is mounted in the IC chip implementation area 23 of the second buildup layer 32 of the wiring board 10. At this time, the surface connection terminals 22 of the IC chip 21 and the respective solder bumps 45 are positioned in correspondence with each other. The solder bumps 45 are heated to a temperature of 220° C. to 240° C., to thus become reflowed, whereupon the respective solder bumps 45 and the surface connection terminals 22 are joined together, and the wiring boards 10 and the IC 21 are electrically connected. Thus, the IC chip 21 is mounted in the IC chip implementation area 23 (see FIG. 1).

Accordingly, the present embodiment yields the following advantages.

(1) Under the method for manufacturing the wiring board 10 of the present embodiment, the first surface 93 and the second surface 94 of the resin layer 92 are activated in the surface activation step S7. When the resin insulation layers 33 and 34 are made in the insulation layer formation step S9-1, the resin insulation layers 34 and 36 can be reliably brought into close contact with the surfaces (the first surface 93 and the second surface 94) of the resin layer 92; hence, the occurrence of delamination, and the like, can be prevented. Therefore, the wiring boards 10 exhibiting superior reliability can be produced.

(2) In the embodiment, there is performed processing pertaining to the roughening step S8 for roughening the surfaces 18 and 19 of the conductor layers 14 and 15 as well as processing pertaining to the surface activation step S7 for activating the surfaces (the first surface 93 and the second surface 94) of the resin layer 92. As a result, there are accomplished enhanced adhesion between the resin insulation layers 33 and 34 and the conductor layers 14 and 15 as well as enhanced adhesion between the resin insulation layers 33 and 34 and the resin layer 92. Therefore, the wiring boards 10 exhibiting greatly enhanced reliability can be produced.

(3) In the embodiment, since the IC chip implementation area 23 is situated within the area located immediately above the ceramic capacitor 101. Therefore, the IC chip 21 implemented on the IC chip implementation area 23 is supported by the ceramic capacitor 101 exhibiting high rigidity and a small thermal expansion coefficient. Therefore, since the second buildup layer 32 becomes less prone to deformation in the IC chip implementation area 23, the IC chip 21 implemented in the IC chip implementation area 23 can be supported more stably. Therefore, the occurrence of cracking or connection failures in the IC chip 21, which would otherwise be attributable to great thermal stress, can be prevented. For this reason, a large-size IC chip measuring 10 mm or more per side that induces an increase in stress (distortion) due to a thermal expansion difference and hence undergoes great thermal stress and that generates a large quantity of heat and undergoes harsh thermal shock during operation or an Low-k (exhibiting a low dielectric constant) IC chip claimed to be brittle can be used as the IC chip 21.

(4) In the embodiment, since the ceramic capacitor 101 is placed at a position immediately below the IC chip 21 implemented in the IC chip implementation area 23. Hence, wiring for connecting the ceramic capacitor 101 to the IC chip 21 becomes shorter, whereby an increase in inductance components of the wiring is prevented. Accordingly, switching noise of the IC chip 21 induced by the ceramic capacitor 101 can reliably be reduced, so that a source voltage can reliably be made stable. Further, since noise entering between the IC chip 21 and the ceramic capacitor 101 can be minimized, high reliability can be accomplished without involvement of failures, such as faulty operation.

The embodiment may also be changed as follows.

In the embodiment, processing pertaining to the surface activation step S7 is carried out immediately after the height adjustment step S6. However, timing at which processing pertaining to the surface activation step S7 is performed may also be changed. For instance, processing pertaining to the surface activation step S7 may also be carried out after the fixing step S5 and before the height adjustment step S6. Moreover, processing pertaining to the surface activation step S7 may also be carried out after the roughening step S8 and before the insulation layer formation step S9-1.

In the conductor formation step S9-2 of the embodiment, electroless plating can also be performed again after abrasion of the filled resin 17. As a result of performance of electroless plating, a plated cap layer is made on both the through hole conductor 16 and the end face of the filled resin 17 adjoining the second major surface 13 as well as on both the through hole conductor 16 and the end face of the filled resin 17 adjoining the first major surface 12, and a plated layer is also made over the via conductors 43 and 47. Subsequently, the substrates are subjected to patterning by means of etching in conformance with the related-art known technique (e.g., a subtractive technique), whereby the plated layer makes up portions of the conductor layers 41 and 42.

In the surface activation step S7 of the embodiment, both the first surface 93 of the resin layer 92 situated on the same side where the first major surface 12 of the core substrate 11 is located and the second surface 94 of the resin layer 92 situated on the same side where the second major surface 13 of the core substrate 11 is located are activated. However, only one of the first surface 93 and the second surface 94 may also be activated in the surface activation step S7. When only any one of the surfaces is activated, it is especially preferable to activate only the second surface 94. The reason for this is that the second surface 94 is a surface remained in contact with an adhesive face of the adhesive tape 171 susceptible to adhesion of extraneous matters and hence may probably become inactive.

In the resin layer formation step S4 of the embodiment, a gap between the inner surface 91 of the accommodation hole 90 and the capacitor side surfaces 106 of the ceramic capacitor 101 is filled with a portion of the resin layer 92 (the resin sheet). However, the gap between the inner wall surface 91 and the capacitor side surfaces 106 may also be filled by charging liquid resin, which is to make the resin layer 92, by use of a dispenser (manufactured by Asymtek K.K.).

In the embodiment, the height adjustment step S6 may be omitted. Further, processing pertaining to a step for making the resin layer 92 on the first major surface 12 and the first capacitor major surface 102 may also be omitted from the resin layer formation step S4.

In the embodiment, the ceramic capacitor 101 is used as a component held in the accommodation hole 90. However, another component, such as DRAM, SRAM, a chip capacitor, and a register, may also be used.

In the solder bump formation step S10 of the embodiment, only the solder bumps 45 used for implementing the IC chip 21 are formed. In addition, solder bumps used for implementing a motherboard may also be made on the pads 49 formed on the resin insulation layer 35.

Technical ideas ascertained by the embodiment are provided below.

(1) A method for manufacturing a wiring board with a built-in component comprising: a core substrate preparation step for preparing a core substrate having a first major surface, a second major surface, and an accommodation hole opened in both the first major surface and the second major surface; a component preparation step for preparing a component having a first component major surface, a second component major surface, and side surfaces; an accommodation step for holding the component in the accommodation hole after the core substrate preparation step and the component preparation step while the second major surface and the second component major surface are oriented toward the same side; a resin layer formation step for filling a gap between an inner wall surface of the accommodation hole and the side surfaces of the component with a resin layer after the accommodation step; a fixing step for hardening the resin layer after the resin layer formation step, to thus fix the component; and a layered wiring area formation step for forming a layered wiring area, which includes a resin insulation layer and a conductor layer stacked one on top of the other, on the second major surface and the second component major surface after the fixing step, wherein processing pertaining to the accommodation step, the resin layer formation step, and the fixing step is carried out while the second-major-surface-side opening of the accommodation hole is closed with an adhesive tape with a adhesive face; when the adhesive tape is removed after the fixing step, a second-major-surface-side surface of the conductor layer formed on the second major surface, is level with a surface of the resin layer adjoining the innermost resin insulation layer after the layered wiring area formation step; and processing pertaining to the surface activation step for activating the surface of the resin layer by means of plasma treatment is performed after the fixing step and before the layered wiring area formation step.

(2) In relation to the technical idea (1), the method for manufacturing a wiring board with a built-in component is characterized in that processing pertaining to a solder bump formation step for forming solder bumps used for implementing a semiconductor integrated circuit element on the conductor layer formed on the outermost resin insulation layer is performed after the layered wiring area formation step.

(3) In relation to the technical idea (1) or (2), the method for manufacturing a wiring board with a built-in component is characterized in that the resin layer formed over the first major surface and the first component major surface in the resin layer formation step comprises a resin sheet; and a portion of the resin sheet is caused to enter the first-major-surface-side opening of the accommodation hole in the resin layer formation step, thereby filling a gap between the inner wall surface of the accommodation hole and the side surfaces of the component.

(4) A method for manufacturing a wiring board with a built-in component comprising: a core substrate preparation step for preparing a core substrate having a first major surface, a second major surface, and an accommodation hole opened at least in the first major surface; a component preparation step for preparing a component having a first component major surface, a second component major surface, and side surfaces; an accommodation step for holding the component in the accommodation hole after the core substrate preparation step and the component preparation step while the second major surface and the second component major surface are oriented toward the same side; a resin layer formation step for filling a gap between an inner wall surface of the accommodation hole and the side surfaces of the component with a resin layer after the accommodation step; a fixing step for hardening the resin layer after resin layer formation step, to thus fix the component; and an insulation layer formation step for forming a resin insulation layer on the second major surface and the second component major surface after the fixing step, wherein there is performed processing pertaining to a surface activation step for activating surfaces of the resin layer by means of plasma treatment after the fixing step and before the insulation layer formation step; processing pertaining to a roughening step for roughening a first-major-surface-side surface of the conductor layer formed on the first major surface is performed after the surface activation step and before the insulation layer formation step; processing pertaining to a cleansing step for cleansing the surface of the resin layer and the first-major-surface-side surface of the conductor layer is performed after the roughening step and before the insulation layer formation step; and the first major surface and the second major surface are subjected to coupling treatment using a silane coupling agent after the cleaning step and before the insulation layer formation step.

(5) A method for manufacturing a wiring board with a built-in component comprising: a core substrate preparation step for preparing a core substrate having a first major surface, a second major surface, and an accommodation hole opened at least in the first major surface; a component preparation step for preparing as a component a capacitor of via array type having a first capacitor major surface, a second capacitor major surface, capacitor side surfaces, a plurality of internal electrode layers stacked by way of dielectric layers, a plurality of intra-capacitor via conductors connected to the plurality of internal electrode layers, and a plurality of surface electrodes connected to at least ends on the second capacitor major surface side of the plurality of intra-capacitor via conductors, the plurality of intra-capacitor via conductors being wholly arranged in an array pattern; an accommodation step for holding the capacitor in the accommodation hole after the core substrate preparation step and the component preparation step while the second major surface and the second capacitor major surface are oriented toward the same side; a resin layer formation step for filling a gap between an inner wall surface of the accommodation hole and the capacitor side surfaces with a resin layer after the accommodation step; a fixing step for hardening the resin layer after resin layer formation step, to thus fix the capacitor; and an insulation layer formation step for forming a resin insulation layer on the second major surface and the second capacitor major surface after the fixing step, wherein processing pertaining to a surface activation step for activating surfaces of the resin layer by means of plasma treatment is performed after the fixing step and before the insulation layer formation step.

What is claimed is:

1. A method for manufacturing a wiring board with a built-in component comprising:
a core substrate preparation step for preparing a core substrate having a first major surface, a second major surface, and an accommodation hole opened at least in the first major surface;
a component preparation step for preparing a component having a first component major surface, a second component major surface, and a side surface;
an accommodation step for holding the component in the accommodation hole after the core substrate preparation step and the component preparation step, while the second major surface and the second component major surface are oriented toward a same side;
a resin layer formation step for filling a gap between an inner wall surface of the accommodation hole and the side surface of the component with a resin layer after the accommodation step;
a fixing step for hardening the resin layer after the resin layer formation step, to thus fix the component;
an insulation layer formation step for forming a resin insulation layer on the second major surface and the second component major surface after the fixing step; and
a surface activation step for activating a surface of the resin layer by means of plasma treatment, after the fixing step but before the insulation layer formation step.

2. The method according to claim 1, wherein a plasma system that generates oxygen plasma is used in plasma treatment.

3. The method according to claim 1,
wherein the resin layer is further formed over the first major surface and the first component major surface in the resin layer formation step, and comprises a resin sheet, and
wherein the resin layer formation step comprises heating the resin sheet and pressing the resin sheet against the core substrate and the component, whereby the gap between the inner wall surface of the accommodation hole and the side surface of the component is filled with a portion of the resin sheet.

4. The method according to claim 1, further comprising a height adjustment step for thinning the resin layer so as to align the surface of the resin layer with a surface of a first conductor layer formed on the first major surface, after the fixing step but before the surface activation step, and
wherein both the surface of the resin layer and the surface of the first conductor layer are activated in the surface activation step.

5. The method according to claim 1,
wherein the accommodation step, the resin layer formation step and the fixing step are carried out while a second opening of the accommodation hole opened in the second major surface is closed with an adhesive tape having an adhesive face, and
wherein the adhesive tape is removed after the fixing step.

6. The method according to claim 1, wherein the resin layer is made of a resin material having substantially the same composition as that of the resin insulation layer.

7. The method according to claim 1, wherein the wiring board has a layered wiring area in which the resin insulation layer and a second conductor layer are stacked on the second major surface and the second component major surface.
